(19) United States
(12) Patent Application Publication
(10) Pub. No.: US 2010/0153539 A1
(43) Pub. Date: Jun. 17, 2010

(54) ALGORITHM FOR CLASSIFICATION OF BROWSER LINKS

(76) Inventors: Gregory Thomas Zarroli, Durham, NC (US); Anthony Wayne Spivey, Holly Springs, NC (US); Matthew Erling Barton, Chapel Hill, NC (US)

Correspondence Address: ROBERT PLATT BELL;REGISTERED PATENT ATTORNEY, P.O. BOX 13165, Jekyll Island, GA, 31527, US

(21) Appl. No.: 12/334,662

(22) Filed: Dec. 15, 2008

(51) Int. Cl. G06F 15/173

(52) U.S. Cl. 709/224

(57) ABSTRACT

A method or algorithm for classifying downloaded links or URL's based on the reason behind the download. Downloads are classified into categories, for example, a “visited” URL or an “embedded” URL. Categorizing these downloads allows other applications to collect information for storage, upload, or other action. This algorithm uses information from the browser history and packet streams to obtain and categorize the links or URL's for classification.

### FIELD OF THE INVENTION

The present invention relates to a method or algorithm for differentiating between browser links (or URL's) visited on a page versus those embedded which are simply embedded on a given Web site.

### BACKGROUND OF THE INVENTION

Web Browsing has become a part of every-day life. At work one may use a Web Browser to access e-mail, interact with customers, or look up information on the Internet. Children use the Web and thus Web Browsers to review assignments from class, turn in homework, or simply socialize with their friends. In the home, people use Web Browsers to read news, manager bills, or plan a vacation, among other uses.

The effectiveness of Web based advertising is an important question with significant economic implications. Businesses such as Google have been extremely successful based on Web based advertising models. In the Prior Art, it was relatively straightforward to count the number of times a specific web page had been downloaded to a device. Counting the number of times a specific web page had been downloaded may be accomplished using techniques that prevent web pages from being cached, effectively allowing the server to count every time the page is downloaded (referred to as “hits”). But, if there are references to a web site embedded into other web sites, the question remains, how many of these “hits” are counted because a user requested the URL (Universal Resource Locator) to be downloaded or whether the URL was merely present in another web page. Prior Art techniques for counting “hits” may thus be inaccurate, and advertisers may be charged improperly for advertising services. For businesses to understand the value of using embedded links for advertising, it would be valuable to know how frequently URLs presented to users are visited.

Another problem with Prior Art web browsing relates to parental monitoring of Web usage. Many web sites, while they themselves may be harmless, may include embedded links that may not be appropriate for children. In the Prior Art, parents may be able to block specific web sites using parental blocking software or services. However such blocking software may block entire websites only, and thus preventing access to web pages with acceptable content for children, as well as more objectionable material. For example, research and encyclopedia sites may contain web pages with information that a child may wish to access to complete a homework assignment or paper. However, links within such pages may lead to other pages with objectionable images or adult content. It would be useful to allow a child to selectively visit a page with non-objectionable material, even if the page contains links to objectionable material, while at the same time blocking links to the objectionable material pages. It would also be useful to parents to know if a particular web page was actually selected by the user, or if it was downloaded only because that particular page was referenced by an embedded URL.

### SUMMARY OF THE INVENTION

For businesses to understand the value of using embedded links for advertising, it would be valuable to know how frequently URLs presented to users are visited. The present invention provides a method and algorithm for determining if a URL was simply presented to the user or if it was actually visited by the user. The power of this method is, given a few pieces of data, a determination can be made whether the user actually clicked the link rather than just had it show up because they visited a site.

With regard to parental monitoring of Web usage, the algorithm and method of the present invention may be used in an application to provide information to parents indicating whether a particular web page was actually selected by the user or if it was downloaded only because it was an embedded URL. This information may also be used within parental blocking software to allow access to web pages that may contain content appropriate for children, while blocking links on such pages which may lead to inappropriate material.

The present invention includes a method and apparatus for differentiating between browser links (or URL's) actually visited on a page versus those links where are simply embedded on a given Web site. Embedded URL's are downloaded simply because they exist on an accessed page, not because they have been specifically requested by the browser user (examples of embedded URL's include but are not limited to images, ads, style-sheets, and the like). In particular, the present invention is directed at classifying browser links for data mining, security, and other purposes.

The method of the invention uses existing browser histories and packet processing to determine the reason the web browser is accessing the requested URL. The result of this classification may be used for different purposes, such as saving URL history and classification for later upload to a server, or for blocking of URL loading and/or display on a user device.

The method or algorithm for classifying downloaded links or URLs is based on the reason behind the download. Downloads are classified into categories, for example, a “visited” URL or an “embedded” URL. Categorizing these downloads allows other applications to collect information for storage, upload, or other action. The algorithm of the present invention uses information from the browser history and packet streams to obtain and categorize the links or URL's for classification.

### BRIEF DESCRIPTION OF THE DRAWINGS

FIG. 1 is a diagram illustrating the set of URL types and their relationship.

FIG. 2 is an illustration of an actual HTTP request (in packet dump mode) with key fields highlighted.

FIG. 3 is a system-level processing diagram.

FIG. 4 is a detailed flow diagram of the URL classification algorithm.

FIG. 5 illustrates three examples of HTTP requests with key fields highlighted and the associated example Browser History.

FIG. 6 is a highlighted version of the flow diagram of FIG. 4, illustrating the flow of HTTP example request 610

FIG. 7 is a highlighted version of the flow diagram of FIG. 4, illustrating the flow of HTTP example request 620.

FIG. 8 is a highlighted version of the flow diagram of FIG. 4, illustrating the flow of HTTP example request 630.

### DETAILED DESCRIPTION OF THE INVENTION

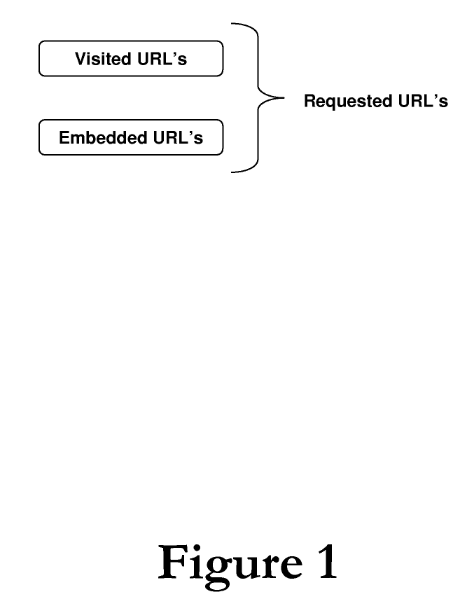

For the purposes of this description, a “requested” URL is defined as any URL being accessed through an HTTP (Hyper-Text Transfer Protocol) request from the web browser. A “visited” URL is the actual URL being visited by the user. An “embedded” URL is any URL that is requested while loading a visited URL, for example, images, ads, or style-sheets. FIG. 1 illustrates the relationship between these three types of URL's. “Visited” and “embedded” URL's are a subset of “requested” URL's.

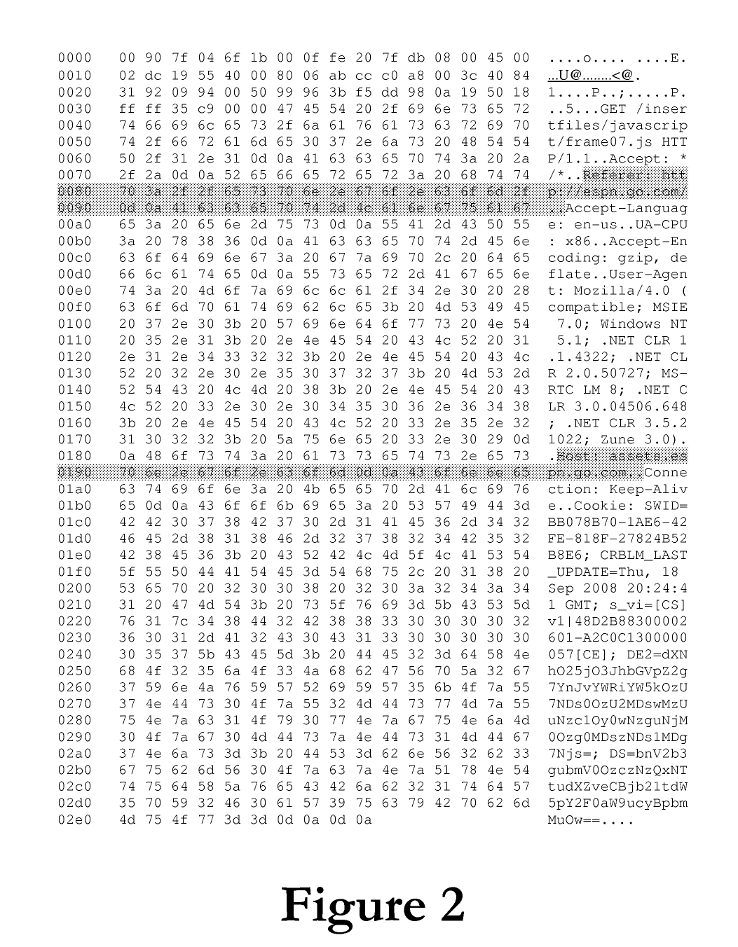

HTTP requests contain two descriptive fields used in the classification algorithm. The first of these fields is the “Host” field. This field is required in an HTTP request and gives the address that is hosting the current requested URL. The second of these fields is the “Referer” field, which is the address that referred the browser or user to the current requested URL. The “Referer” field is optional in HTTP requests. FIG. 2 contains an actual HTTP request with these two descriptive fields highlighted.

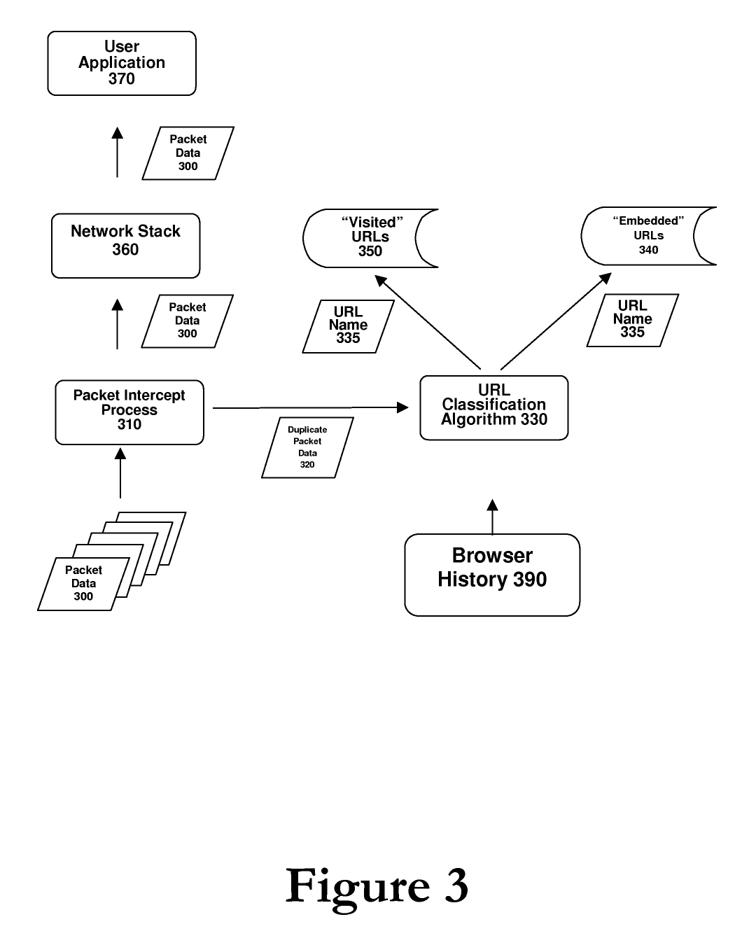

The algorithm of the present invention classifies the request into either a “visited” URL or “embedded” URL using these fields and allows for storage into one or more databases. These databases can be remotely or locally located and can take many different forms. The database for “visited” URL's is represented by component 350 of FIG. 3. The database for “embedded” URL's is represented by component 340 of FIG. 3.

Packets received on a device implementing this algorithm are intercepted in a device specific manner. Packets may be analyzed directly or duplicated and provided to the algorithm (component 330 of FIG. 3). FIG. 3 illustrates an approach where the packet is intercepted and duplicated for processing by this algorithm. Component 300 represents a stream of data packets. Each packet may or may NOT be an HTTP request. Component 310 represents the device specific manner in which packets are duplicated and provided to the URL Classification Algorithm (Component 330). Component 320 represents a duplicated packet being passed to URL Classification Algorithm. Component 330 processes the incoming packet and classifies the packet with additional information obtain from Browser History (Component 390), providing the URL names to the appropriate databases (Components 340 and 350). Remaining components (360, 370) represent normal system processing that is unaffected by the URL Classification Algorithm.

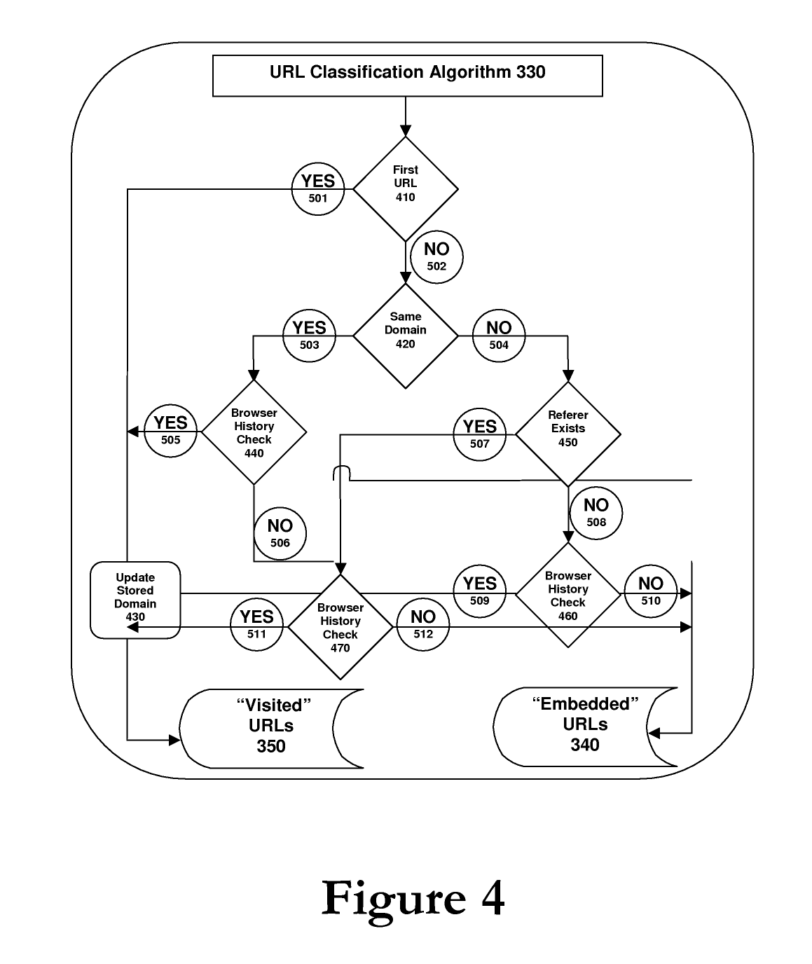

FIG. 4 represents a flow chart of the URL Classification Algorithm (Component 330). Referring to FIG. 4, each HTTP request contains the requested URL, the domain (defined by the “Host” field), and optionally the “Referer”. In step 410, the first HTTP request is assumed to be a “visited” URL. Every time a URL is classified as a “visited” URL, the “stored domain” is updated to the domain represented in the “Host” field in step 430. This “stored domain” is then used for comparisons with other URL's.

If the requested URL is not first, as determined by step 410, then the domain is compared against the “stored domain” in step 420. If the domains are the same, and the requested URL is not in the browser history as determined in step 440, then it is determined that the requested URL is an “embedded” URL and database 340 may be updated. If the requested URL is in the browser history, as determined in step 440, then the requested URL is classified as a “visited” URL in database 350.

If the domain of the requested URL is different from the “stored domain”, as determined in step 420, then the optional “Referer” field may be examined in step 450. If the “Referer” field does not exist in the HTTP request, and the requested URL appears in the browser history, as determined in step 460, then this is classified as a “visited” URL and database 350 is updated. If the “Referer” field doesn't exist in the HTTP request, as determined by step 450, and the requested URL is not in the browser history, as determined in step 460, then this URL is classified as an “embedded” URL and database 340 is updated.

If the “Referer” field exists in the HTTP request, as determined in step 450, then the domain of the referer (the “referer domain”) is compared against the “stored domain” in step 470. If they are the same, and the requested URL is in the browser history, then this is classified as a “visited” URL and database 350 is updated. If the “stored domain” and the “referer domain” are the same, as determined in step 450, but the requested URL is not in the browser history, as determined in step 470, then the URL is classified as an “embedded” URL and database 340 is updated.

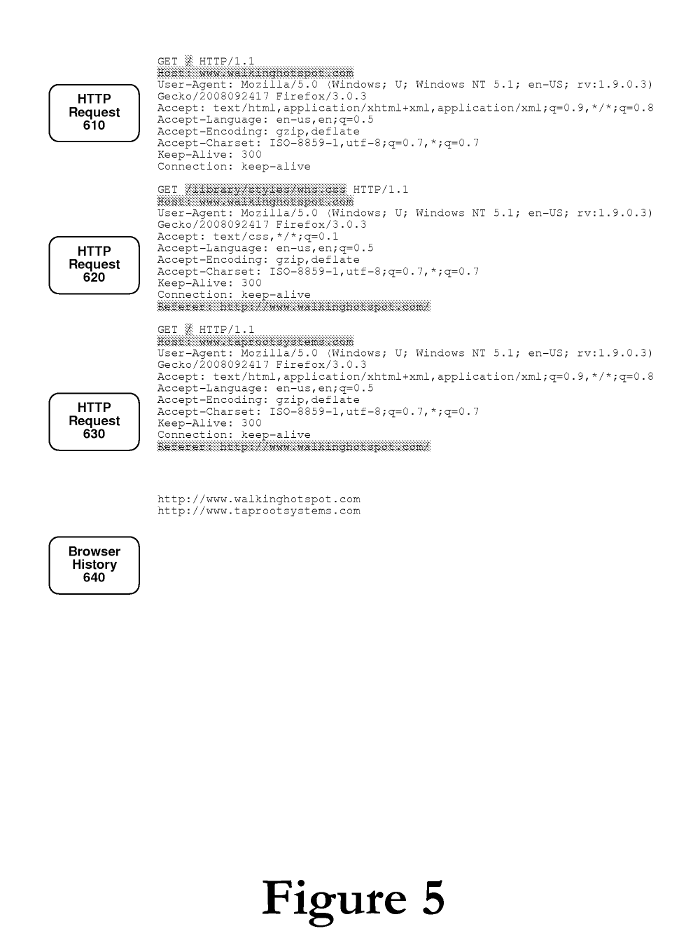

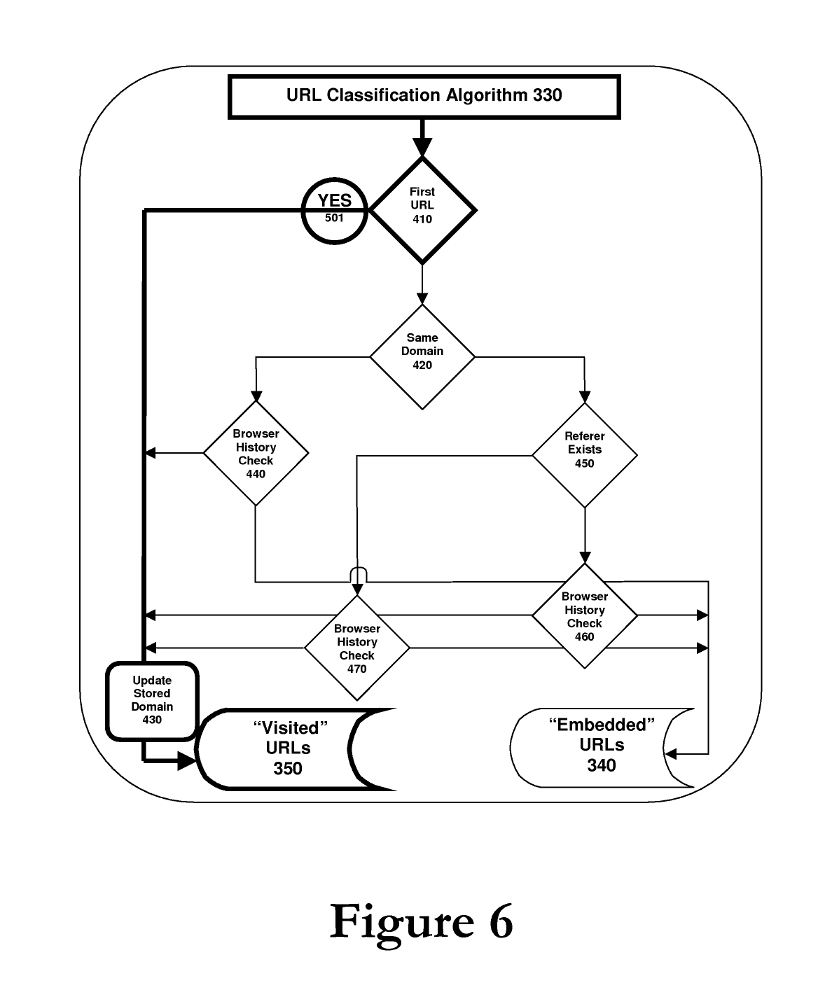

FIG. 5 illustrates three examples of HTTP requests with key fields highlighted and the associated example Browser History. The purpose of these examples is to walk through the invention flow chart illustrated in FIG. 4 using the sample HTTP requests 610, 620, 630 and the sample Browser History 640 of FIG. 5. To support these examples, the three flow charts of FIGS. 6-8 will show the highlighted path taken for the three HTTP requests being analyzed, using the flow chart of FIG. 4 described above.

Referring to FIG. 5, HTTP request 610, is the first URL received in this example list of HTTP requests. Referring to FIG. 6, Step 410 analyzes the URL provided by the Host field (http://www.walkinghotspot.com/), and makes Decision 501 that this is the First URL in the sequence of HTTP Requests. The next step is to Update Stored Domain in Step 430, which in turn, classifies the URL of HTTP request 610 as a “Visited” URL, stores domain www.walkinghotspot.com as a Stored Domain in step 430, and updates “Visited” URLs database 350.

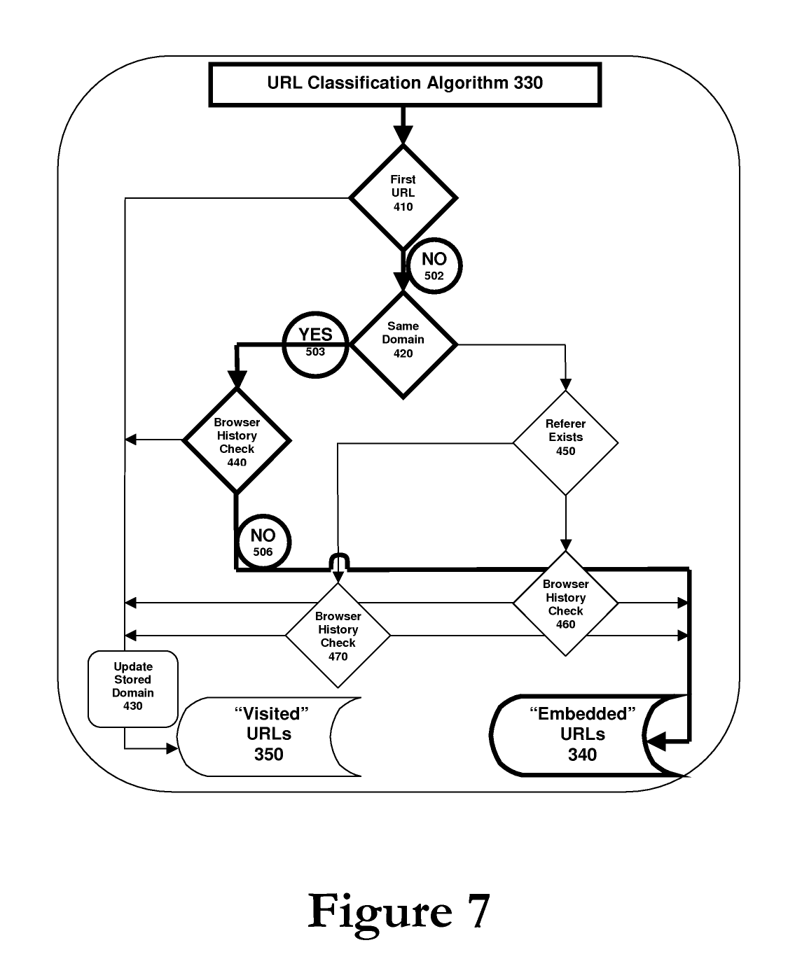

Referring back to FIG. 5, the next HTTP request in the example, HTTP request 620, contains the URL www.walkinghotspot.com/library/styles/whs.css, and this is not the First URL in this example list of HTTP requests, which was discovered during the processing as described with regard to FIG. 6. Referring to FIG. 7, Step 410 analyzes whether the HTTP 620 request contains the First URL, and Decision 502 is reached. Next, in Step 420, the “Host” field, or Domain, www.walkinghotspot.com is compared to the Stored Domain www.walkinghotspot.com obtained during the processing described with regard to FIG. 6. The example shows they are equal, producing Decision 503. After performing Step 440 and checking the Browser History 640, the exact URL is not found; therefore, decision 506 is made, which classifies the URL www.walkinghotspot.com/library/styles/whs.css of HTTP request 620 as an “Embedded” URL in database 340.

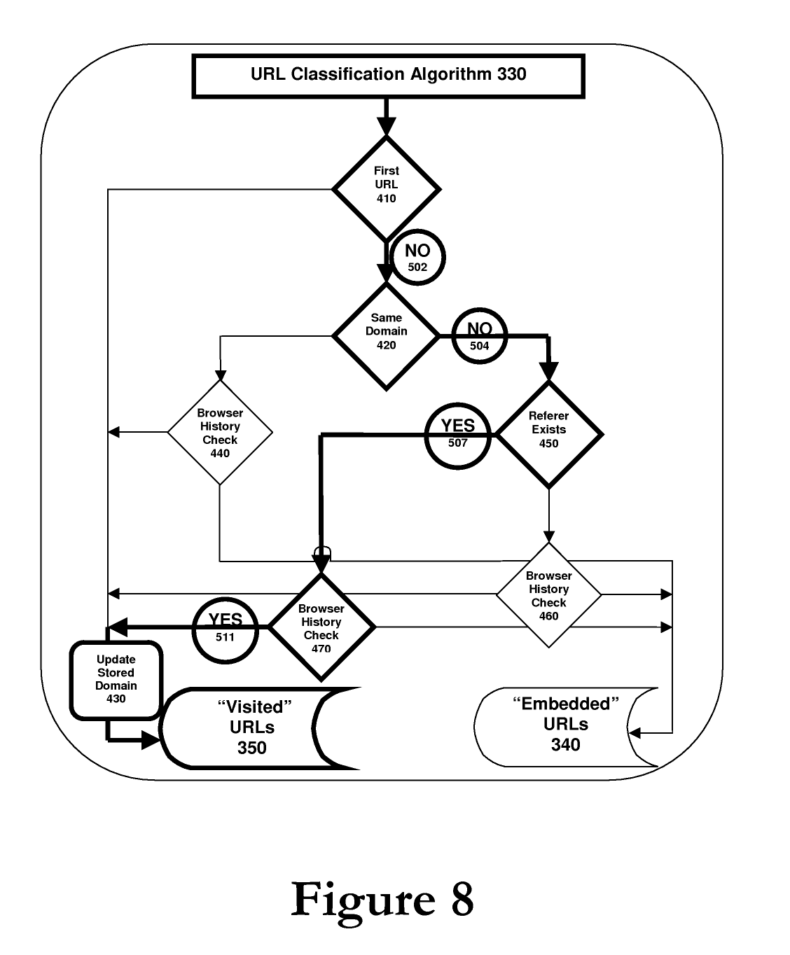

Referring back to FIG. 5, the final HTTP request in the example is HTTP request 630, which has URL and Domain given in the ‘Host’ field (www.taprootsystems.com), and this is different from the Stored Domain (www.walkinghotspot.com). Referring to FIG. 8, Step 410 analyzes whether the HTTP request contains the First URL in the sequence of HTTP Requests, and Decision 502 is reached. Next, in Step 420, the Domain www.taprootsystems.com is analyzed, and Decision 504 is reached, because the domain is not the same as the Stored Domain www.walkinghotspot.com. Next the Referer Exists analysis in Step 450 is performed. The HTTP request 630 shows that the Referer field exists, and Decision 507 is made, which then requires a Browser History check in Step 470. In this example, referring back to FIG. 5, Browser History 640 contains a URL, which matches the requested URL (http://www.taprootsystems.com) provided in the HTTP Request, so Decision 511 is made. This leads to Update Stored Domain in Step 430. Finally, the URL www.taprootsystems.com in HTTP request 630 is now classified as a “Visited” URL.

The examples illustrated in FIGS. 6-8 show how a URL can be determined to be a “Visited” or “Embedded” URL. As the algorithm of the present invention can determine the difference between an actual visit and an embedded URL, the present invention may provide a means by which an advertiser can more accurately determine whether a website has actually been visited, or whether just the embedded URL has been displayed. Advertising rates may be determined based on total number of hits (visited and embedded) and also on how many hits actually lead to a visit to the website of interest. Such data may be output as a ratio of hits to visits, or as raw data indicating the number of visited URLs (database 350) and embedded URLs (database 340).

For parental control or other type of access restriction software, the algorithm may be used to allow a user to access a page with an embedded URL, which may be on a blacklist, but prevent the user from visiting the page on the blacklist. As the user browses the web, the URLs are classified according to the algorithm 330. If a URL is determined to be an embedded URL 340, the user's access to a page with that embedded URL may be allowed. However, if the URL is a visited (or attempted visit) to a blacklisted URL (determined by comparing the visited URL database 350 with a predetermined blacklisted database 350) then access to such a database may be denied or logged. In addition, the present invention may be used by web crawlers or the like to determine whether a blacklisted URL is embedded in another web page, in order to determine whether additional web pages should be black-listed.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A method for determining whether an HTTP (HyperText Transfer Protocol) request to a Uniform Resource Locator (URL) comprises an actual visit to a web page (Visited URL) designated by the URL or a visit to a web page containing the URL embedded in that web page (Embedded URL), the method comprising the steps of:
intercepting packets of data from a user;
analyzing the packets of data to locate URLs in the packets of data to determine whether the packet contains an HTTP request;
if a packet contains an HTTP request, analyzing the HTTP request to locate a requested URL, a corresponding domain (defined by a Host field), and the presence of a Referer field in the HTTP request; and
determining whether an HTTP request to a URL comprises Visited URL or an Embedded URL based upon the presence or absence of the Referer field.

2. The method of claim 1, wherein:
if the HTTP request is a first HTTP request in the packets of data from a user, the HTTP request is assumed to be a Visited URL and the HTTP request is classified as a Visited URL, then the method further includes the steps of:
updating a Visited URL database to include information as to the Visited URL, and
storing the domain represented in the Host field as a stored domain.

3. The method of claim 2, wherein:
if the requested URL is not the first HTTP request in the packets of data from the user, the domain in the HTTP request is compared against a stored domain; and
if the stored domain is the same as the domain in the HTTP request, and the requested URL is not in the browser history, then it is determined that the requested URL is an Embedded URL; and the Embedded URL database is updated to include information as to the Embedded URL.

4. The method of claim 3, wherein:
if the requested URL is in the browser history, then the requested URL is classified as a Visited URL, and the Visited URL database is updated to include information as to the Visited URL.

5. The method of claim 4, wherein if the domain of the requested URL is different from the stored domain, and the Referer field is detected, then content of the Refer field is examined to determine whether the URL is a Visited URL or an Embedded URL.

6. The method of claim 5, wherein if the Referer field does not exist in the HTTP request, and the requested URL appears in the browser history, then the URL is classified as a Visited URL and the Visited URL database is updated to include information as to the Visited URL.

7. The method of claim 6, wherein if the Referer field doesn't exist in the HTTP request and the requested URL is not in the browser history, then the URL is classified as an Embedded URL and the Embedded URL database is updated to include information as to the Embedded URL.

8. The method of claim 7, wherein if the Referer field exists in the HTTP request, then the domain of the Referer is compared against the “stored domain” and if the domain of the Referer is the same as the stored domain, and the requested URL is in the browser history, then the URL is classified as a Visited URL and the Visited URL database is updated to include information as to the Visited URL.

9. The method of claim 8, wherein if the “stored domain” and the domain of the Referer are the same, but the requested URL is not in the browser history, then the URL is classified as an Embedded URL and the Embedded URL database is updated to include information as to the Embedded URL.

10. The method of claim 1, wherein determination of whether an HTTP request to a URL comprises an actual visit to a web page designated by the URL or a visit to a web page containing an the URL embedded in that web page determines advertising hit rates for an advertiser advertising on a web page.

11. The method of claim 10, wherein an advertiser is charged a first rate for Visited URLs and a second rate for Embedded URLs.

12. The method of claim 1, wherein determination of whether an HTTP request to a URL comprises an actual visit to a web page designated by the URL or a visit to a web page containing an the URL embedded in that web page determines whether a user can access a restricted web site.

13. The method of claim 12, wherein if the URL is a visited URL, the visited URL is compared to a list of restricted URLs and the user is denied access to the visited URL if the visited URL is on the list of restricted URLs.

14. The method of claim 13, wherein if the URL is a embedded URL, is granted access to a page having the embedded URL.

15. The method of claim 14, wherein if the if the URL is an embedded URL, the embedded URL is compared to a list of restricted URLs and the web page with the embedded URL is flagged for review.
